(19) United States
(12) Patent Application Publication
(10) Pub. No.: US 2010/0153112 A1
(43) Pub. Date: Jun. 17, 2010

(54) PROGRESSIVELY REFINING A SPEECH-BASED SEARCH

(75) Inventors: W. Garland Phillips, Barrington, IL (US); Harry M. Bliss, Evanston, IL (US); Bashar Jano, Algonquin, IL (US); Changxue Ma, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/335,840

(22) Filed: Dec. 16, 2008

(51) Int. Cl. G06F 17/30; G10L 15/18; G10L 15/00

(52) U.S. Cl. 704/257; 704/E15.001

(57) ABSTRACT

Disclosed are editing methods that are added to speech-based searching to allow users to better understand textual queries submitted to a search engine and to easily edit their speech queries. According to some embodiments, the user begins to speak. The user's speech is translated into a textual query and submitted to a search engine. The results of the search are presented to the user. As the user continues to speak, the user's speech query is refined based on the user's further speech. The refined speech query is converted to a textual query which is again submitted to the search engine. The refined results are presented to the user. This process continues as long as the user continues to refine the query. Some embodiments present the textual query to the user and allow the user to use both speech-based and non-speech-based tools to edit the textual query.

### FIELD OF THE INVENTION

The present invention is related generally to computer-mediated search tools and, more particularly, to using human speech to refine a search.

### BACKGROUND OF THE INVENTION

In a typical search scenario, a user types in a search string. The string is submitted to a search engine which analyzes the string and then returns its search results to the user. The user may then choose among the returned results. However, often the results are not to the user's liking, so he chooses to refine the search. (Here, “refine” means to narrow or to broaden or to otherwise change the scope of the search or the ordering of the results.) To do this, the user edits the original search string, possibly adding, deleting, or changing terms. The altered search string is submitted to the search engine (which typically does not remember the original search string), which begins the process all over again.

However, this scenario does not work so well when the user is searching from a small personal communication device (such as a cellular telephone or a personal digital assistant). These devices usually do not have room for a full keyboard. Instead, they have restricted keyboards that may have many tiny keys too small for touch typing, or they may have a few keys, each of which represents several letters and symbols. Users of these devices find that their restricted keyboards are unsuitable for entering and editing sophisticated search queries.

Instead of typing their queries, users of these personal devices are turning to speech-based searching. Here, a user speaks a search query. A speech-to-text engine converts the spoken query to text. The resulting textual query is then processed as above by a standard text-based search engine.

While good in theory, speech-based searching presents several problems. The speech-to-text conversion may not be exact, leading to spurious search results. Also, human speech often includes repetitions and “non-words” (such as “uh” and “hmm”) which can confuse the speech-to-text engine. In either case, the user usually does not know exactly what textual search query was submitted to the search engine. Thus, he may not realize that his speech query was interpreted incorrectly. In turn, because the search results are based on the (possibly misinterpreted) search query, the returned results might not be what he asked for. When it comes time to refine the search, the user cannot start with the original speech-based query and refine it but must instead refine the query in his head and then speak again the whole refined query, with clarity and without non-words.

### BRIEF SUMMARY

The above considerations, and others, are addressed by the present invention, which can be understood by referring to the specification, drawings, and claims. According to aspects of the present invention, speech-based and non-speech-based editing methods are added to speech-based searching to allow users to better understand the textual queries submitted to the search engine and to easily edit their speech queries.

According to some embodiments, the user begins to speak. The user's speech is translated into a textual search query and submitted to a search engine. The results of the search are presented to the user. As the user continues to speak, the user's speech query is refined based on the user's further speech. The refined speech query is converted to a textual query which is again submitted to the search engine. The refined results are presented to the user. This process continues as long as the user continues to refine the query.

Some embodiments help the user to understand the search query he is producing by presenting the textual query (created by the speech-to-text engine) to the user. Non-words and non-search terms (“a,” “the,” etc.) are usually not presented. Some of the search terms in the textual query are highlighted to show that the speech-to-text engine has a high level of confidence that these terms are what the user intended. The user can edit this textual query using further speech input. As the user continues to speak, he watches the confidence level of different terms change. For example, the user may repeat a word (“boat, boat, boat”) to raise the confidence level of that term, or he can lower a term's confidence level (“not goat, I meant boat”). As the user continues to speak, the textual search query changes to more closely match what he wanted to say.

Some embodiments also allow the user to manipulate the textual query with non-speech-based tools, such as text-based, handwriting-based, graphical-based, gesture-based, or similar input/output tools. The user can increase or decrease the confidence level of terms, can group terms into phrases, or can perform Boolean operations (e.g., AND, OR, NOT) on the terms. As above, the modified search query is submitted to the search engine. Some embodiments allow both speech-based and non-speech-based editing, either simultaneously or consecutively.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIGS. 2a and 2b are simplified schematics of a personal communication device that supports multiple modes of refining a speech-based search;

FIG. 3 is a flowchart of an exemplary method for progressively refining a speech-based search;

FIG. 4 is a flowchart of an exemplary text-based method for refining a speech-based search; and

FIG. 5 is a dataflow diagram showing an exemplary application of the method of FIG. 4.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

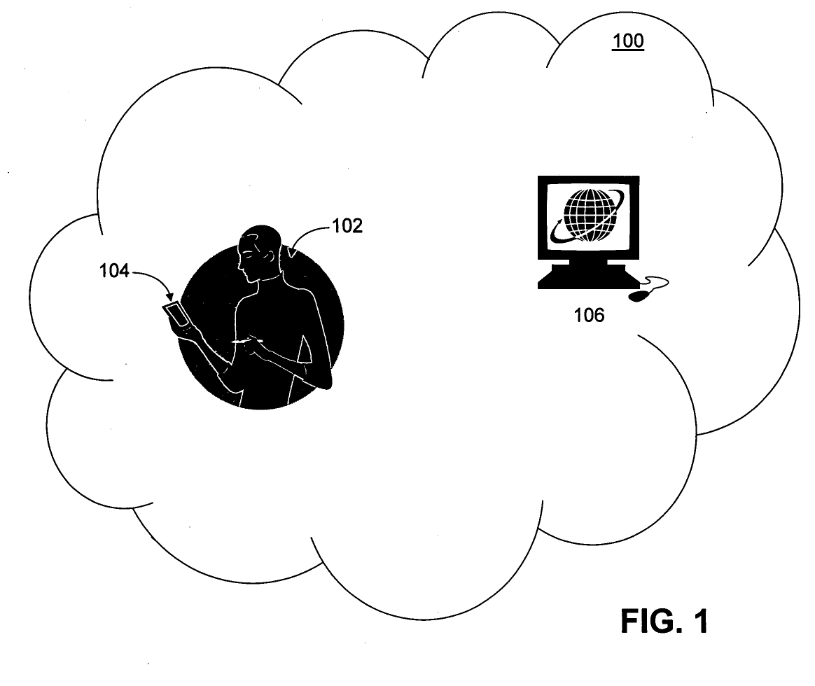

In FIG. 1, a user 102 is interested in launching a search. For whatever reason, the user 102 chooses to speak his search query into his personal communication device 104 rather than typing it in. The speech input of the user 102 is processed (either locally on the device 104 or on a remote search server 106) into a textual query. The textual query is submitted to a search engine (again, either locally or remotely). Results of the search are presented to the user 102 on a display screen of the device 104. The communications network 100 enables the device 104 to access the remote search server 106, if appropriate, and to retrieve “hits” in the search results under the direction of the user 102.

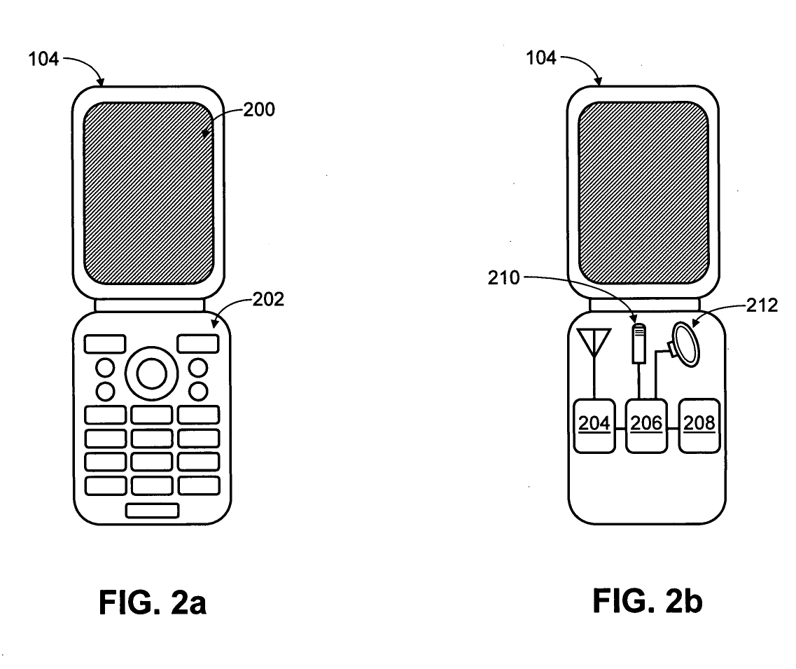

FIGS. 2a and 2b show a personal communication device 104 (e.g., a cellular telephone, personal digital assistant, or personal computer) that incorporates an embodiment of the present invention. FIGS. 2a and 2b show the device 104 as a cellular telephone in an open configuration, presenting its main display screen 200 to the user 102. Typically, the main display 200 is used for most high-fidelity interactions with the user 102. For example, the main display 200 is used to show video or still images, is part of a user interface for changing configuration settings, and is used for viewing call logs and contact lists. To support these interactions, the main display 200 is of high resolution and is as large as can be comfortably accommodated in the device 104. A device 104 may have a second and possibly a third display screen for presenting status messages. These screens are generally smaller than the main display screen 200. They can be safely ignored for the remainder of the present discussion.

The typical user interface of the personal communication device 104 includes, in addition to the main display 200, a keypad 202 or other user-input devices.

FIG. 2b illustrates some of the more important internal components of the personal communication device 104. The device 104 includes a communications transceiver 204, a processor 206, and a memory 208. A microphone 210 (or two) and a speaker 212 are usually present.

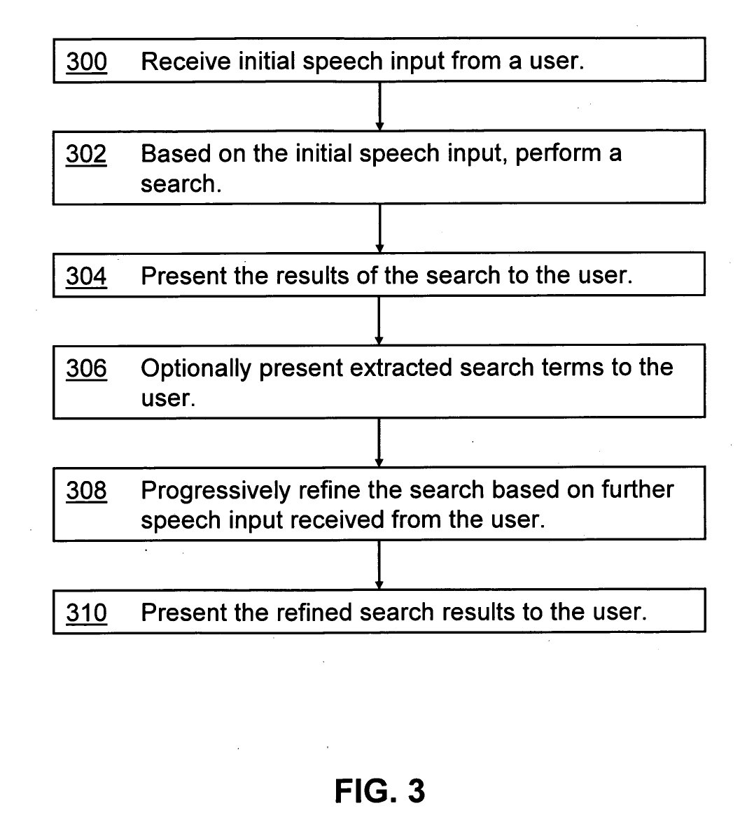

Because the results of a search might not exactly match what the user 102 wanted, aspects of the present invention allow the user 102 to refine the search results. FIG. 3 presents an embodiment of one method for refining the results of a speech-based search. The method begins in step 300 where the user 102 speaks the original search into the microphone 210 of his personal communication device 104.

In step 302, the speech query of the user 102 is analyzed. For a speech-based search query, the analysis often involves extracting key search terms from the speech and ignoring non-words and non-search terms. The extracted key search terms are then turned into a textual search query. The textual search query is submitted to a search engine (local or remote). The search engine processes the textual search query, runs the search, and returns the results of the search.

In step 304, the results of the search are presented on the display screen 200 of the personal communication device 104. Often, a search returns more “hits” than can be indicated on the display screen 200. In this case, the search engine presents on the display screen 200 those results that it deems the “best,” measured by some criteria. For some embodiments, these criteria include how important each extracted search term is in each hit. Many criteria are known from the realm of text-based searching. For example, Term-Frequency-Inverse Document Frequency is a measure of how important a search term is in a specific document. A document in which the search term is important by this criterion is pushed higher in the results list than a document that contains the search term but in which the search term is not very important. Other text-based criteria are known for ranking hits and can be used in embodiments of the present invention.

A variation on these criteria is important in processing a speech-based search. When a user types in a search, the search engine knows exactly the search string that is entered. That is not always the case with a spoken search query. The search engine may incorrectly interpret a search term in the spoken search query. Thus, in some embodiments of the present invention, each search term extracted from a spoken search query is assigned a confidence level. A high confidence level means that the search engine is fairly sure that it correctly interpreted the spoken search term and correctly translated it into a textual search term.

When presenting the results of the search in step 304, the order of the results is determined, in part, by the confidence level assigned to each search term. A low confidence level means that the search engine may well have misinterpreted the search term and thus that search term should not be given much weight in ranking the search results.

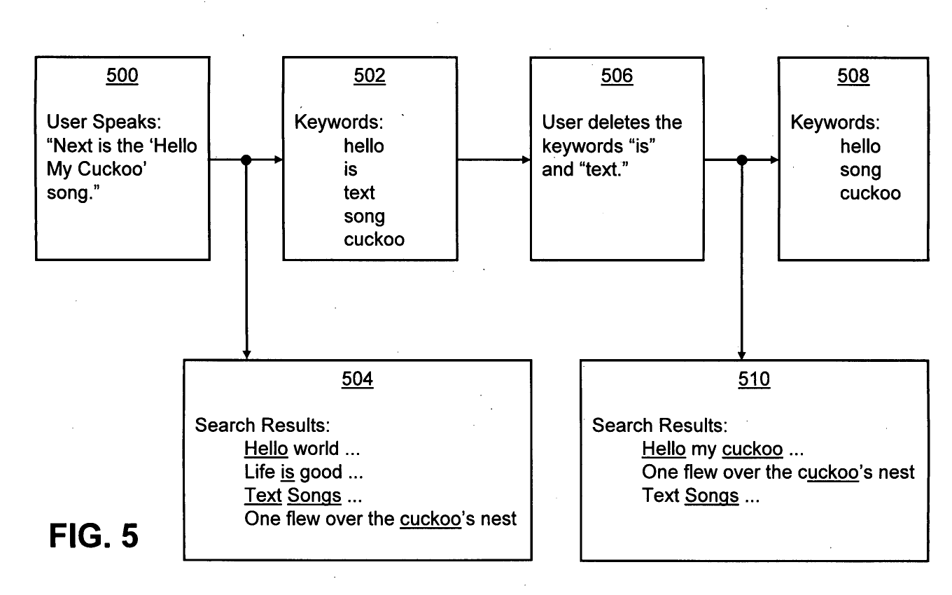

Step 306 is optional but highly useful for a speech-based search. Here, the extracted search terms are presented on the screen 200 of the personal communication device 104. This allows the user 102 to see exactly how the search engine interpreted the search query, so the user 102 can know how to regard the results of the search. If, for example, the display of the extracted search terms shows that a key term was mis-interpreted by the search engine, then the user 102 knows that the search results are not what he wanted. The confidence level of the each search term can be shown, giving the user 102 further insight into the speech-interpretation process and into the meaning of the search results. The example of FIG. 5, discussed below, illustrates some of these concepts.

In step 308, the user 102 progressively refines the search results by giving further speech input to the search engine. This can take several forms, used together or separately. For example, the user 102 sees (based on the output of the optional step 306) that an important search term (e.g., “boat”) was assigned a low confidence level. The user 102 then repeats that search term (“boat, boat, boat”), taking the effort to speak very clearly. The search engine, based on this further speech input, revises its interpretation of the spoken search query and raises the confidence level of the repeated search term. The search engine refines the search based on the increased confidence level of the repeated search term and presents the refined search results to the user 102 in step 310.

The user 102 can also speak to replace a misunderstood search term: “Not goat, I meant boat.”

The user 102 can also refine the search even when the search engine made no errors in interpreting the original spoken search query. For example, the search engine can begin to search as soon as the user 102 begins to speak, basing the search on the terms already extracted from the speech of the user 102. The presented search results, based only on the original search terms extracted so far, may be very broad in scope. As the user 102 continues to speak, more search terms are extracted and are logically combined with the previous search terms to refine the search string. The refined search results, based on the further search terms, becomes more focused as the user 102 continues to speak.

A clever search engine can also interpret spoken words and phrases such as “OR,” “AND,” “NOT,” “BEGIN QUOTE,” and “END QUOTE” as logical operatives that explicitly refine the search query.

The above techniques can be repeated as the user 102 refines the search based on both the search results and on the extracted search terms presented on the screen 200 of his personal communication device 104. Using these techniques, the user 102 can narrow the search, broaden it, and change the relative importance of search terms in order to change the results and the ordering of the results.

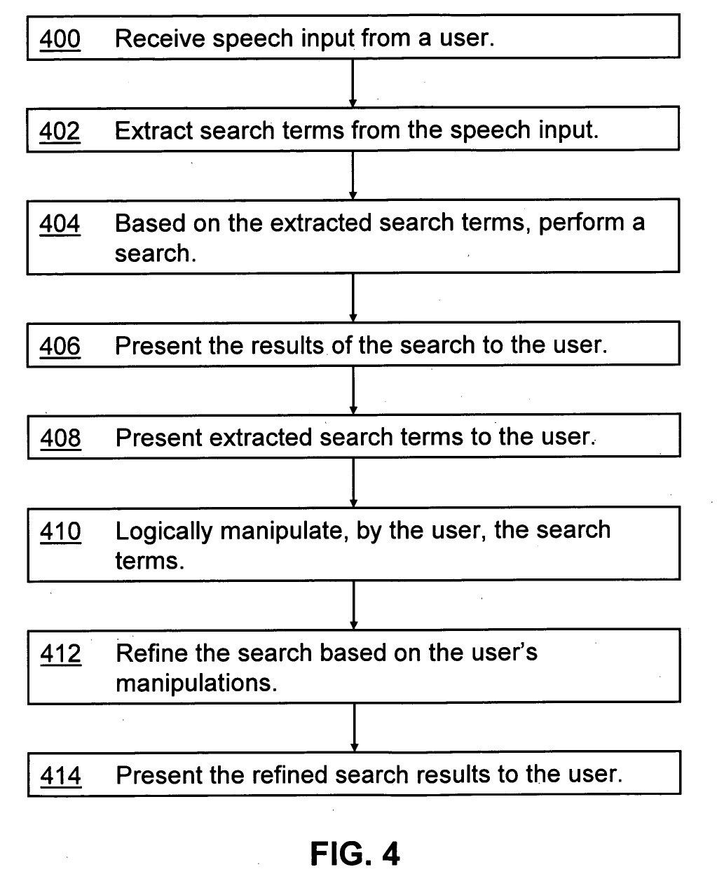

FIG. 4 presents another method for refining a speech-based search. In its initial steps, this method is similar to the method of FIG. 3. The user 102 speaks a search query (step 400), search terms are extracted from the spoken query (step 402), the extracted search terms are converted into a textual search query which serves as the basis for a search (step 404), and the results (or at least the “better” results) are presented to the user 102 (step 406). Along with the results, the extracted search terms are presented to the user (step 408), possibly with an indication of the confidence level assigned to each term.

In step 410, the user 102 is given the opportunity to manipulate the extracted search terms. In some embodiments, the user 102 is presented with a text editor to manipulate the terms. The user 102 can eliminate some terms, add others, increase the confidence level of a term (that is, confirm that the search engine correctly interpreted the search term by, for example, touching the term on a touch-based user interface), logically group the terms (to, for example, create compound words or phrases), and perform Boolean operations on the extracted terms. In this manner, text-editing tools are used to refine the original speech-based search query. A refined search, based on the manipulations of the user 102, is performed in step 412, and the refined results are presented to the user 102 in step 414. As with the method of FIG. 3, the above steps can be repeated as the user 102 continues to refine the search until he receives the results he wants.

Some embodiments support in step 410 other user-input devices in addition to, or instead of, a text editor. For example, facial gestures of the user 102 can be interpreted as editing commands. This is useful where the user 102 cannot free his hands from other purposes while editing the search string.

The methods of FIGS. 3 and 4, though different, are clearly compatible. An embodiment of the present invention can allow the user 102 to simultaneously use speech-based and non-speech-based tools to refine the search.

FIG. 5 presents an example of refining a speech-based search. Because patents are printed documents, FIG. 5 shows the use of text-based editing techniques, but the same results can be obtained using a purely speech-based interface or with a hybrid of the two.

In box 500 of FIG. 5, the user 102 speaks the search query “Next is the ‘Hello My Cuckoo’ song.” Box 502 shows the search terms extracted by the search engine from the spoken query. Note that the search engine mistook the spoken word “next” as “text” and ignored (or did not catch) the words “the” and “my.” In some embodiments, the search engine only shows those extracted terms that have been assigned a relatively high level of confidence.

Box 504 shows the results of the original search based on the extracted search terms of box 502. The extracted search terms, or at least those with a relatively high level of confidence, are highlighted in the search results, shown in box 504 by underlining.

In response to the results presented in box 504, the user 102 in box 506 deletes the two extracted keywords “is” and “text.” In another example, the user 102 may replace the incorrectly interpreted keyword “text” with the correct keyword “next.” In the present example, the user 102 realizes that “next” is not helpful and lets it go.

The modified list of search terms is shown in box 508, and the modified results are presented in box 510. As this point, the user 102 can apply the techniques discussed above to continue to refine the search or may simply choose among the results shown in box 510.

According to aspects of the present invention, the user 102 applies different speech-based and non-speech-based methods to refine a speech-based search query. The end result is that, at the least, the user 102 understands better why the search engine is producing its results and, at best, the user 102 receives the search results that he wants.

In view of the many possible embodiments to which the principles of the present invention may be applied, it should be recognized that the embodiments described herein with respect to the drawing figures are meant to be illustrative only and should not be taken as limiting the scope of the invention. For example, different user interfaces for editing a search query may be appropriate in different situations and on devices of differing capabilities. Therefore, the invention as described herein contemplates all such embodiments as may come within the scope of the following claims and equivalents thereof.

We claim:

1. A method for progressively refining a speech-based search, the method comprising:
receiving initial speech input from a user;
performing a search, the search based, at least in part, on the initial speech input;
presenting at least some results of the search to the user; and
as the user continues to speak, refining the search based, at least in part, on further speech input received from the user and presenting at least some refined search results to the user.

2. The method of claim 1 wherein performing a search comprises extracting one or more search terms from the initial speech input and extracting one or more search terms from the further speech input.

3. The method of claim 2 wherein presenting at least some results of the search comprises selecting results to present, the selecting based, at least in part, on ranking by confidence the extracted search terms.

4. The method of claim 2 further comprising:
presenting at least some extracted search terms to the user.

5. The method of claim 4 wherein presenting at least some extracted search terms to the user comprises marking search terms that are assigned a higher confidence.

6. The method of claim 2 wherein refining the search comprises:
assigning a higher confidence in the search to a search term extracted from the further speech input than a confidence assigned to a search term extracted from the initial speech input.

7. The method of claim 2 wherein refining the search comprises:
assigning a higher confidence in the search to a repeated extracted search term than to a non-repeated extracted search term.

8. The method of claim 2 wherein refining the search comprises:
assigning a lower confidence to a search term extracted from early in the speech input received from the user.

9. The method of claim 1 wherein refining the search comprises:
performing a new search, the new search based, at least in part, on the initial speech input and on the further speech input received from the user.

10. A method for refining a speech-based search, the method comprising:
receiving speech input from a user;
extracting one or more search terms from the received speech input;
performing a search, the search based, at least in part, on the extracted search terms;
presenting at least some results of the search to the user;
presenting at least some extracted search terms to the user;
receiving a command from the user to logically manipulate the presented search terms;
refining the search, the refining based, at least in part, on the logical manipulation command received from the user; and
presenting at least some refined search results to the user.

11. The method of claim 10 wherein presenting at least some results of the search comprises selecting results to present, the selecting based, at least in part, on ranking by confidence the extracted search terms.

12. The method of claim 10 wherein presenting at least some extracted search terms to the user comprises marking search terms that are assigned a higher confidence.

13. The method of claim 10 wherein receiving a command from the user comprises receiving an element from the group consisting of: tactile input, keyed input, gestural input, and speech input.

14. The method of claim 10 wherein the command to logically manipulate the presented search terms comprises an element selected from the group consisting of: remove a search term from consideration, change a confidence level of a search term, combine a plurality of search terms into a search phrase, create a logical disjunction of search terms, create a logical conjunction of search terms, and change a logical precedence within a search string.

15. The method of claim 10 wherein refining the search comprises:
performing a new search, the new search based, at least in part, on the logical manipulation command received from the user.

16. A personal communication device comprising:
a microphone configured for receiving speech input from a user;
an output device; and
a processor operatively connected to the microphone and to the output device, the processor configured for performing a search, the search based, at least in part, on initial speech input received from the user, for presenting on the output device at least some results of the search to the user, and, as the user continues to speak, for refining the search based, at least in part, on further speech input received from the user and for presenting on the output device at least some refined search results to the user.

17. The personal communication device of claim 16 wherein the output device is selected from the group consisting of: a speaker and a display screen.

18. The personal communication device of claim 16 further comprising:
a transceiver operatively connected to the processor;
wherein performing a search comprises transmitting a search query to a remote device and receiving search results from the remote device.

19. A personal communication device comprising:
a microphone configured for receiving speech input from a user;
an input device;
an output device; and
a processor operatively connected to the microphone, to the input device, and to the output device, the processor configured for extracting one or more search terms from speech input received from the user, for performing a search, the search based, at least in part, on the extracted search terms, for presenting on the output device at least some results of the search to the user, for presenting on the output device at least some extracted search terms to the user, for receiving on the input device a command from the user to logically manipulate the presented search terms, for refining the search, the refining based, at least in part, on the logical manipulation command received from the user, and for presenting on the output device at least some refined search results to the user.

20. The personal communication device of claim 19 wherein the input device is selected from the group consisting of: the microphone, a keypad, and a graphical user interface.

21. The personal communication device of claim 19 wherein the output device is selected from the group consisting of: a speaker and a display screen.

22. The personal communication device of claim 19 further comprising:
a transceiver operatively connected to the processor;
wherein performing a search comprises transmitting a search query to a remote device and receiving search results from the remote device.
